(19) United States
(12) Patent Application Publication
(10) Pub. No.: US 2017/0136957 A1
(43) Pub. Date: May 18, 2017

(54) VEHICLE TOOLBOX

(71) Applicant: Gary Kirtley, Vicksburg, MI (US)

(72) Inventor: Gary Kirtley, Vicksburg, MI (US)

(73) Assignee: OWENS PRODUCTS, INC., Sturgis, MI (US)

(21) Appl. No.: 14/938,923

(22) Filed: Nov. 12, 2015

(51) Int. Cl. B60R 9/06

(52) U.S. Cl. CPC B60R 9/065

(57) ABSTRACT

A vehicle toolbox includes a top portion and a bottom portion. The top portion includes a bin with a top opening and a lid connected to the bin and configured to pivot between an open and closed position. The bottom portion includes an enclosure having a front opening and one or more drawers positioned within the enclosure. A door is connected to the enclosure and able to pivot between open and close positions. The toolbox is sized to fit within dimensions of a given vehicle, such as a truck bed having two sidewalls. The top portion may have a width that is greater than the distance between the two sidewalls. The bottom portion may have a width that is less than the distance between the two sidewalls.

### FIELD OF INVENTION

The present invention generally relates to an apparatus and method for providing organized storage on a vehicle, and specifically to an toolbox organizer configured to integrate with a vehicle bed or storage area.

### BACKGROUND

Utility vehicles such as pickup trucks and the like often include large beds or storage areas. The truck beds are commonly used to stow or haul large cargo. Many pickup truck users, however, use the truck bed for more than just hauling large cargo. For example, many professionals that use pickup trucks, such as contractors, builders, or other blue-collar professionals, use various work tools that require storage and organization. While tools may be stored in a truck bed, the bed on its own does not provide any organization or confine the tools to a set space.

One common solution is to position a toolbox or container within the bed of the truck. The container may be fixed to the truck at any appropriate position. For example, some containers are mounted over a sidewall of the truck bed. Other containers are mounted entirely within the truck bed, either along a sidewall or at an end of the bed. While such containers or boxes provides a smaller and more confined area for tools and the like, they often lack the organization or storage that is truly needed. For example, larger or longer tools may need a long or deep bin in order to be stored. By contrast, smaller tools may be difficult to find or reach in a deep bin and may be better organized and accessed in a small bin or drawer. Therefore, toolboxes with only a single bin or various sized bins fail to provide sufficient storage and organization.

Accordingly, an improved vehicle toolbox with improved storage and organization is needed in the art.

### SUMMARY

A vehicle toolbox is generally presented. The vehicle tool box includes a top portion and a bottom portion. The top portion includes a bin with a top opening and a lid connected to the bin and configured to pivot between an open and closed position. The bottom portion includes an enclosure having a front opening and one or more drawers positioned within the enclosure. A door is connected to the enclosure and able to pivot between open and close positions.

The dimensions of the toolbox may be sized to fit within dimensions of a given vehicle, such as a truck bed having two sidewalls. The top portion may have a width that is greater than the distance between the two sidewalls. The bottom portion may have a width that is less than the distance between the two sidewalls.

The toolbox may be located at any appropriate position within the truck bed, such as near a cab or near an opening of the truck bed.

In an embodiment, the toolbox may include a single door configured to pivot upward to provide access to the front opening of the enclosure. In an alternative embodiment, the toolbox may include one or more doors connected to a center post or side posts of the enclosure and pivot with respect thereto.

In an embodiment, the one or more drawers may be arranged in a vertical stack, or in side by side vertical stacks.

The drawers may include features such as lighting and detents within the drawer slides to provide various opening positions. The lid may be self-opening to allow the lid to open without a force applied thereto.

### BRIEF DESCRIPTION OF THE DRAWINGS

The operation of the invention may be better understood by reference to the detailed description taken in connection with the following illustrations, wherein:

FIG. 1 illustrates a perspective view of a vehicle toolbox having a slide up bottom door and three-drawer bottom section;

FIG. 2 illustrates a perspective view of a vehicle toolbox having inward swinging bottom doors and three-drawer bottom section;

FIG. 3 illustrates a perspective view of a vehicle toolbox having outward swinging bottom doors and three-drawer bottom section;

FIG. 4 illustrates a perspective view of a vehicle toolbox having a slide up bottom door and three-drawer bottom section;

FIG. 5 illustrates a front view of a vehicle toolbox;

FIG. 6 illustrates a side view of a vehicle toolbox;

FIG. 7 illustrates a perspective view of a vehicle toolbox positioned at a cab end of a truck bed;

FIG. 8 illustrates a front view of a vehicle toolbox positioned in a truck bed; and

FIG. 9 illustrates a perspective view of a vehicle toolbox positioned at a hatch end of a truck bed.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A vehicle toolbox 10 is generally presented. The vehicle toolbox 10 may be a storage device having a plurality of compartments for storing and organizing objects, such as tools. The vehicle toolbox 10 may be configured to integrate with a portion of a vehicle. For example, the vehicle toolbox may be mountable within the bed of a pickup truck.

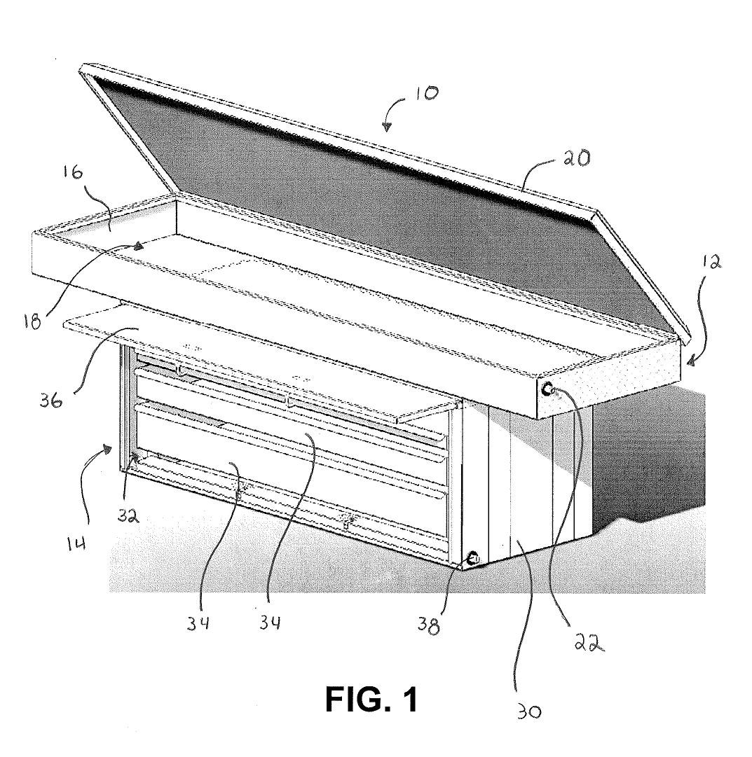

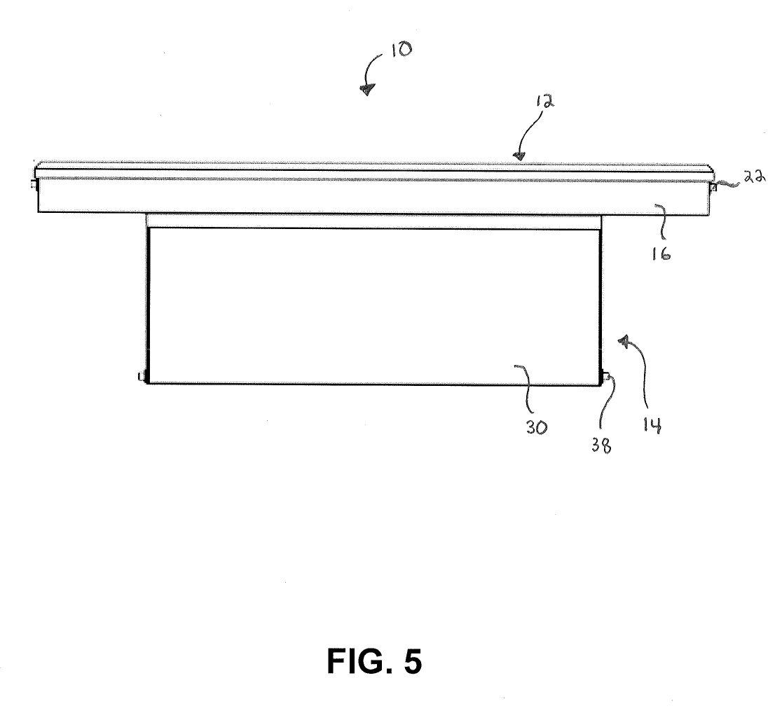

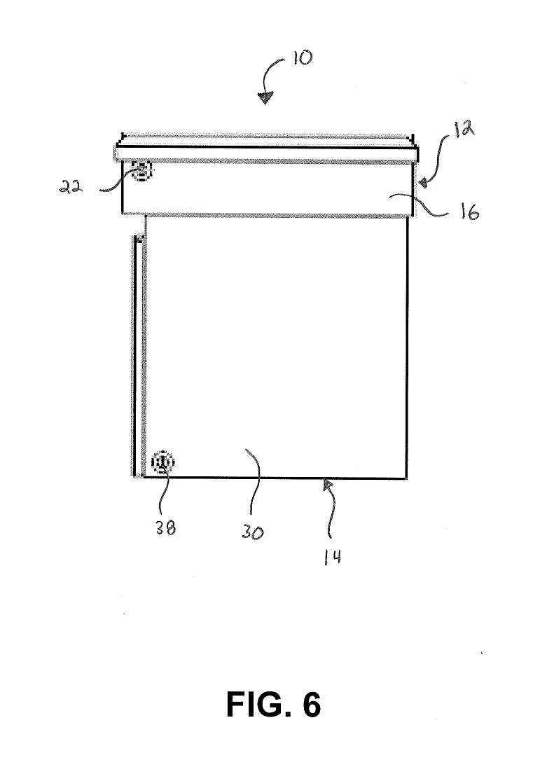

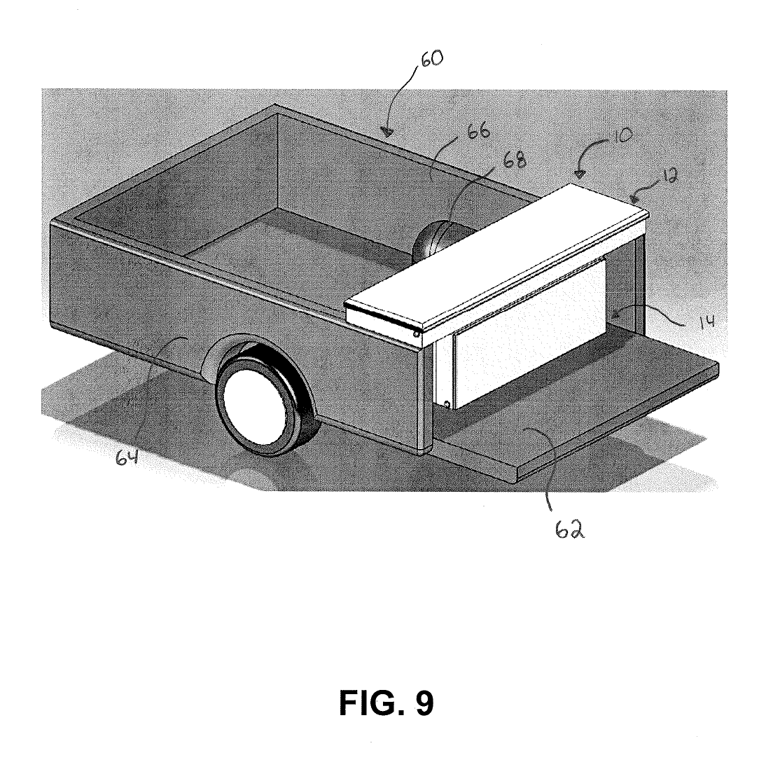

As generally shown in FIGS. 1-9, the vehicle toolbox 10 may include a top storage section 12 and a bottom storage section 14. The top section 12 and bottom section 14 may be connected or integrally formed together to comprise a unitary toolbox. For example, the top section 12 and bottom section 14 may be formed of metal, such as stainless steel, and welded or bolted together. It will be appreciated, however, that the top and bottom sections 12, 14 may be connected or formed together in any manner known in the art.

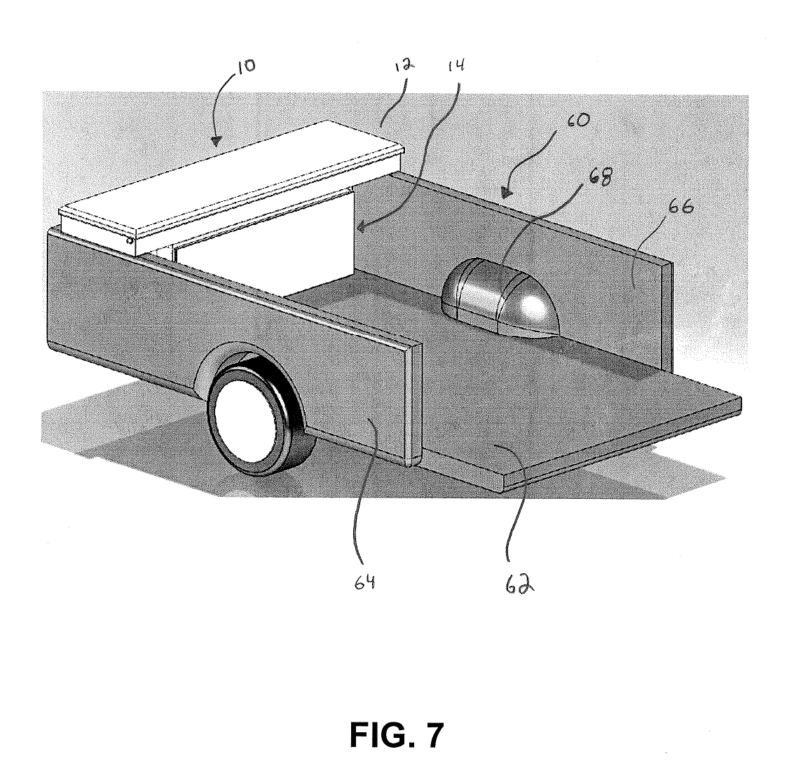

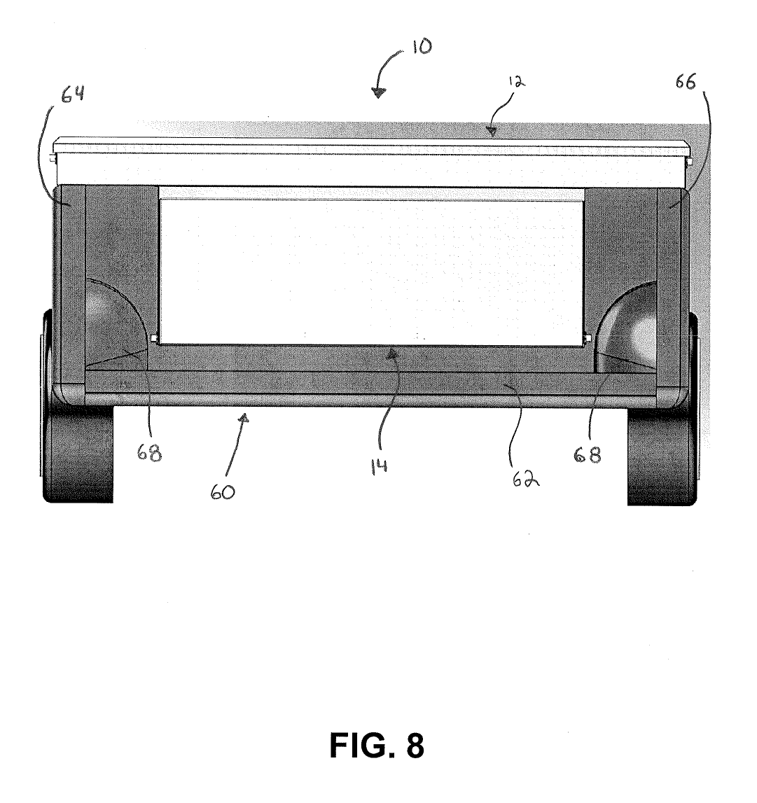

The top section 12 may generally form a bin 16 having a top opening 18. The bin 16 may include compartments therein, or may form a single open space. A lid 20 may be connected to the bin to cover the top opening 18, or a portion thereof. The lid 20 may be hinged or otherwise pivotally connected to the bin 16 and capable of moving between an open position, as shown in FIG. 1, and a closed position, as shown in FIGS. 7 and 8. The lid 20 may open to any appropriate angle, such as open to 90 degrees with respect to the base of the bin 16.

The lid may include a lock 22. The lock 22 may be a key lock or any other appropriate type of lock. The lock 22 may be configured to lock the bin lid 20 in a closed position.

In an embodiment, the bin lid 20 may be self-opening. For example, the top section 12 may include a cylinder (not shown), such as a pneumatic cylinder, connected between the bin 16 and the lid 20. Alternatively, the bin lid 20 may be connected to the bin 16 via a biased or spring-loaded hinge. When the lid 20 is unlocked or unlatched, the cylinder or biased hinge may apply a force to automatically open the bin lid 20 without the need for any external force or with only a reduced external force.

While the lid 20 is shown as a single unitary part in FIGS. 1-9, it will be appreciated that the lid 20 may include various portions to selectively cover or close portions of the top opening 18.

The bottom section 14 may be connected to the top section 12. For example, a top side of the bottom section 14 may be connected to a bottom side of the top section 12 such that the bottom section 14 is positioned underneath or below the top section 12.

The bottom section may comprise an enclosure 30 having a front opening 32. The enclosure may be any appropriate size and shape, such as generally rectangular cuboid, with the front opening 32 positioned on the font side of the cuboid. The front opening 32 may be covered by an appropriate door or lid, as described in further details in the paragraphs below.

The bottom section 14 may include a plurality of drawers 34 positioned within the enclosure 30. The drawers 34 may be arranged in any appropriate manner. For example, the drawers 34 may be stacked vertically or arranged side by side horizontally. The drawers 34 may vary in size and shape in order to house tools or objects of various size and shape. The drawers 34 may further include various detents within the drawer slides to allow the drawers 34 to be opened and held at various positions.

In an embodiment, the drawers 34 may include interior lighting. For example, the drawers 34 may include strip lighting, such as LED strip lighting, arranged in the interior of the drawers 34 to increase visibility within the drawers 34. Likewise, the bin 16 may include lighting, such as strip LED lighting, therein.

As illustrated in FIGS. 1-4, the bottom section 14 may include any appropriate door configured to cover the front opening 32. Each door type may also be utilized with any appropriate configuration of drawers 34.

In an embodiment illustration in FIG. 1, the bottom section 14 may include a slide up door 36. The slide up door 36 may open from and latch to a bottom portion of the front opening 32. The slide up door 36 may pivot up and slide into a space above the drawers 34 near the top of the enclosure 30. The door 36 may include a lock 38 near the bottom portion of the opening 32. The lock 38 may be a key lock or any other appropriate type of lock. The lock 38 may lock the door 36 in closed position when it is closed.

The bottom section 14 may include a plurality of drawers 34, such as three drawers 34, that extend the entire length of the enclosure 30. The drawers 34 may be stacked vertically, as shown in FIG. 1, and may vary in depth. When the

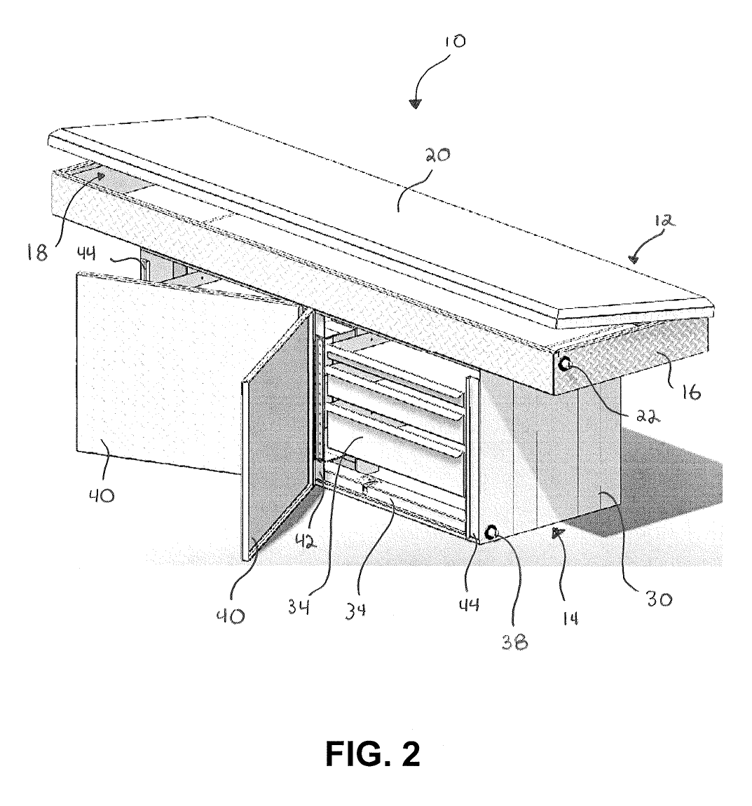

In embodiments illustrated in FIGS. 2-4, the drawers 34 may be arranged both vertically stacked and horizontally side by side. For example, the drawers 34 maybe arranged in side by side vertical stacks. As shown in FIGS. 2-4, the bottom section may include two vertical stacks of drawers 34 that together extend the interior length of the enclosure 30. However, it will be appreciated that the bottom section 14 may include any number of stacks of drawers 34 arranged side by side.

In an embodiment illustrated in FIG. 2, the bottom section 14 may include outward swinging doors 40. The outward swinging doors 40 may be hinged to a center post 42 and may each latch to an end post 44 on the interior of the front opening 32. The enclosure 30 may include a lock 38 to lock each of the outward swinging doors 40 in closed position. Each outward swinging door 40 may provide access to a different vertical stack of drawers 34.

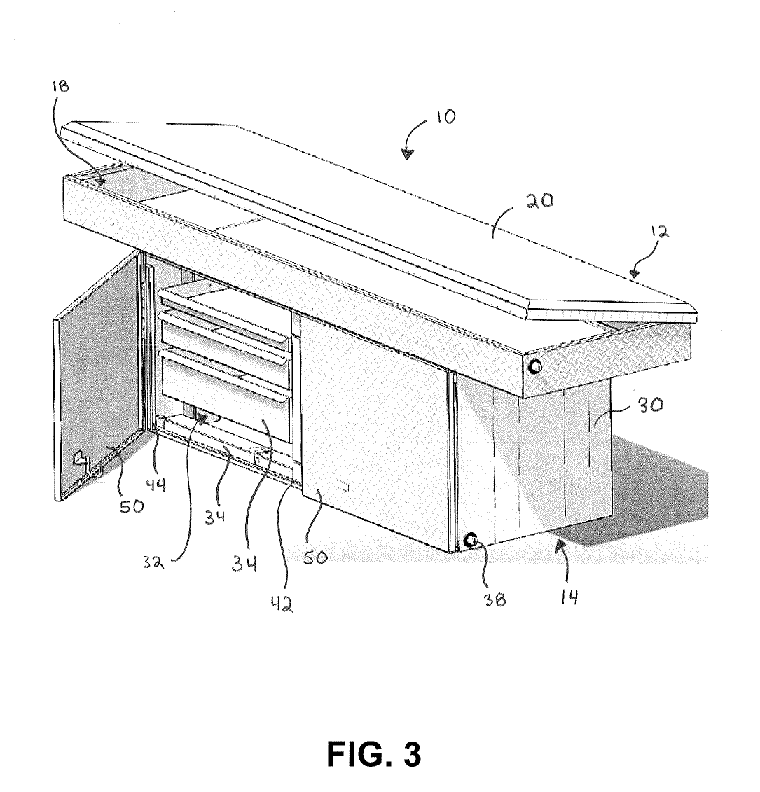

In an embodiment illustrated in FIG. 3, the bottom section 14 may include inward swinging doors 50. The inward swinging doors 50 may be hinged to end posts 44 located at the interior sides of the front opening, and may each latch to the center post 42. The enclosure 30 may include a lock 38 to lock each of the inward swinging doors 50 in closed position. Each outward swinging door 50 may provide access to a different vertical stack of drawers 34.

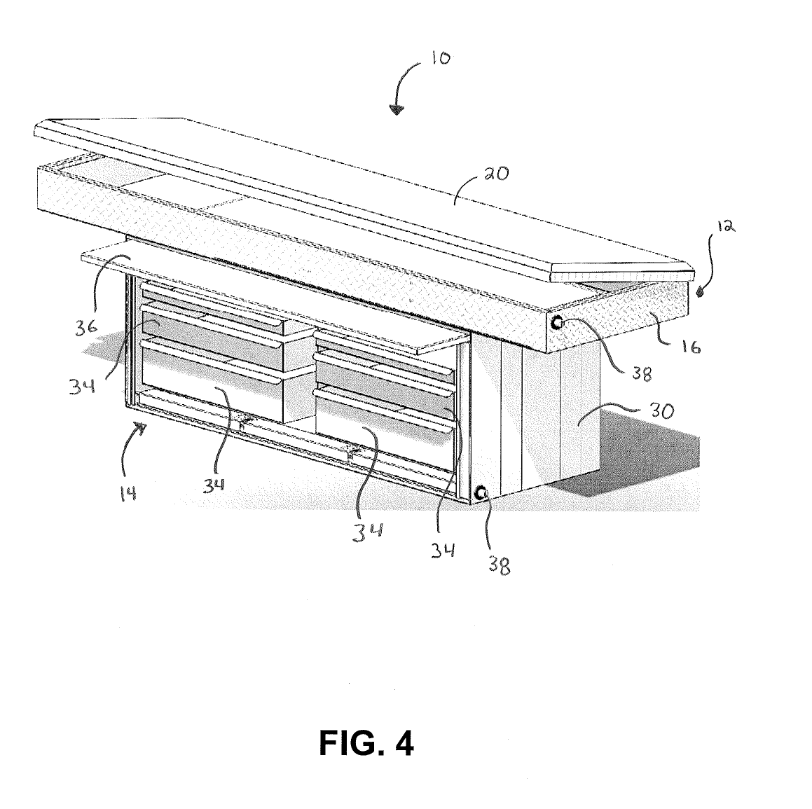

In an embodiment illustration in FIG. 4, the bottom section 14 may include a slide up door 36 with side by side vertical stacks of drawers 34. The slide up door 36 may open from and latch to a bottom portion of the front opening 32, and may lock in a closed position, as described above.

The bin lid lock 22 and enclosure door lock 38 may both operate with a key. The locks 22, 38 may be configured to utilize and receive the same key for operation of the locks.

The toolbox 10 may be specifically sized to integrate with portions of a vehicle, such as a pickup truck bed. For example, a pickup truck may include a bed 60 having bed base 62, a first sidewall 64 connected to the bed base 62, and a second sidewall 66 connected to the bed base 62. The bed 60 may extend from the cab of the vehicle to an end of the vehicle. In standard sized vehicles, the bed base 62 may extend approximately six (6) feet cab section of the vehicle to an end opening. Further, the distance between the sidewalls may be approximately four (4) feet. However, it will be appreciated that the toolbox 10 may be configured to integrate with any different vehicle having different bed dimensions.

The width of the toolbox 10 may be defined as the dimension from left side to right side when facing the front opening 32 on the bottom section 14. The top portion 12 may have a width that is greater than the distance between the first sidewall 64 and second sidewall 66. As shown in FIGS. 7-9, the top portion 12 may extend over and rest on the sidewalls 64, 66. The top portion 12 may be connected to the top of the sidewalls 64, 66, such as bolted or welded thereto, or may rest freely above or on top of the sidewalls.

The bottom portion 14 may have a width that is less than the distance between the two sidewalls 64, 66. As shown in FIGS. 7-9, the bottom portion may be positioned between the sidewalls 64, 66 when the top portion 12 is positioned on top of the sidewalls 64, 66.

In an embodiment, the truck bed 60 may include wheel wells 68. The wheel wells 68 may comprise indentations in the side walls 64, 66 to provide appropriate space for the wheels. The width of the bottom portion 14 may be less than the distance between the wheel wells 68 to allow the toolbox 10 to slide from a back portion of the bed 60 along the length of the bed 60 to a desired location. The toolbox 10 may be fixed at any appropriate location along the length of the bed 60, such as adjacent to the cab of the truck or near the bed opening.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof

Having thus described the invention, we claim:

1. A vehicle toolbox comprising:
a top portion having a first width, the top portion comprising:
a bin having a top opening therein;
a bin lid connected to the bin, wherein the bin lid is configured to pivot with respect to the bin between a closed position where the bin lid is covering the top opening and an open position where the top opening is accessible;
a bottom portion having a second width and connected to a bottom side of the top portion, the bottom portion comprising:
an enclosure having a front opening therein;
one or more drawers within the enclosure; and
a door configured to move between an open position wherein the front opening is accessible and a closed position wherein the front opening is at least partially covered covered;
wherein the first width and second width are sized to correspond to dimensions of a given vehicle having a bed, a first sidewall connected to the bed, and a second sidewall connected to the bed and positioned a distance away from the first sidewall;
wherein the width of the top portion is greater than the distance between the first sidewall and the second sidewall; and
wherein the width of the bottom portion is less than the distance between the first sidewall and second sidewall.

2. The vehicle toolbox of claim 1, wherein the door is a configured to pivot upwards toward an open position.

3. The vehicle toolbox of claim 1, wherein the door includes at least two portions each connected to and configured to pivot with respect to a center post positioned near a center portion of the front opening.

4. The vehicle toolbox of claim 1, wherein the door includes at least two portions each connected to and configured to pivot with respect to end posts positioned near ends of the front opening.

5. The vehicle toolbox of claim 1, wherein the bottom portion includes one or more drawers stacked vertically.

6. The vehicle toolbox of claim 1, wherein the bottom portion includes a first vertical stack of one or more drawers and a second vertical stack of one or more drawers adjacent to the first stack.

7. The vehicle toolbox of claim 1, wherein the one or more drawers comprise a plurality of drawers of different sizes.

8. The vehicle toolbox of claim 1, further comprising lighting positioned within the one or more drawers.

9. The vehicle toolbox of claim 1, wherein the top portion includes a first lock configured to lock the bin lid into a closed position.

10. The vehicle toolbox of claim 8, wherein the bottom portion includes a second lock configured to lock the door in a closed position.

11. The vehicle toolbox of claim 9, wherein the first and second locks are lockable with a key, and further comprising a key capable of locking both the first and second locks.

12. The vehicle toolbox of claim 1, wherein the bin lid is capable of opening without a force applied thereto.

13. A vehicle toolbox assembly comprising:
a truck bed having a bed base, a first sidewall, and a second sidewall located a distance away from said first sidewall;
a toolbox connected to said truck bed, said toolbox comprising:
a top portion having a bin with an opening therein and a lid connected to the bin, wherein the lid is configured to pivot with respect to the bin between a closed position where the lid is covering the opening and an open position where the top opening is accessible;
a bottom portion connected to a bottom side of the top portion, the bottom portion including an enclosure with a front opening, a plurality of drawers within the enclosure, and a door configured to move between an open position wherein the front opening is accessible and a closed position wherein the front opening is at least partially covered;
wherein the bottom portion is positioned between the first and second sidewalls and the top portion is positioned above the first and second sidewalls.

14. The vehicle toolbox of claim 13, wherein the door is a configured to pivot upwards toward an open position.

15. The vehicle toolbox of claim 13, wherein the door includes at least two portions each connected to and configured to pivot with respect to the enclosure.

16. The vehicle toolbox of claim 13, wherein the bottom portion includes a first vertical stack of one or more drawers and a second vertical stack of one or more drawers adjacent to the first stack.

17. The vehicle toolbox of claim 13, wherein the one or more drawers comprise a plurality of drawers of different sizes.

18. The vehicle toolbox of claim 13, further comprising lighting positioned within the one or more drawers.

19. The vehicle toolbox of claim 13, wherein the lid and door are lockable using a single key.

20. The vehicle toolbox of claim 13, wherein the bin lid is capable of opening without a force applied thereto.
